(19) United States
(12) Patent Application Publication
(10) Pub. No.: US 2006/0186365 A1
(43) Pub. Date: Aug. 24, 2006

(54) Electromagnetic drive device and fuel injection valve using the same

(75) Inventor: Shinobu Hirayama, Nishio-city (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/352,290

(22) Filed: Feb. 13, 2006

(30) Foreign Application Priority Data
Feb. 21, 2005 (JP) 2005-44372

(51) Int. Cl. F16K 31/02

(52) U.S. Cl. 251/129.21

(57) ABSTRACT

An electromagnetic drive device has yokes that are magnetically connected with each other and cover an outer periphery of a coil. The coil is wound around a spool. Terminals are guided by a guiding portion of the spool and are fit to the spool. Ends of the coil are electrically connected with ends of the terminals. Protrusions are formed on both circumferential side faces of the spool. The ends of the terminals are bent toward the circumferential ends of the yoke until the ends are locked by tapered faces formed on the protrusions. Accordingly, work for bending electric connections between the coil and the terminals is facilitated, and an insulation failure between the terminals or the coil and the yoke can be prevented.

### CROSS REFERENCE TO RELATED APPLICATION

This application is based on and incorporates herein by reference Japanese Patent Application No. 2005-44372 filed on Feb. 21, 2005.

### BACKGROUND OF THE INVENTION

1. Field of the Invention

The present invention relates to an electromagnetic drive device and a fuel injection valve using the same.

2. Description of Related Art

An electromagnetic drive device that supplies electricity from a terminal to a coil to generate an electromagnetic drive force is used as a drive portion in various usages, for example, as in a fuel injection valve described in JP-A-H10-196486. For example, as show in FIG. 10, in a known electromagnetic drive device, ends 202 of terminals 200 are electrically connected with ends 212 of a coil (not shown) wound around a spool 210, and a yoke 220 covers an outer periphery of the coil. As shown in FIG. 10, the ends 202 of the terminals 200 connected with the ends 212 of the coil are bent toward the yoke 220 so that the ends 202 do not protrude outward in radial directions.

However, it is difficult to adjust a bending amount for bending the ends 202 of the terminals 200 toward the yoke 220. If the bending amount of the ends 202 toward the yoke 220 is too large, the terminals 200 and the yoke 220 will approach each other too close. In such a case, there is a possibility of an insulation failure.

### SUMMARY OF THE INVENTION

It is therefore an object of the present invention to provide an electromagnetic drive device and a fuel injection valve using the same capable of facilitating work for bending an electric connection between a coil and a terminal toward a yoke and of inhibiting an insulation failure between the terminal or the coil and the yoke.

According to an aspect of the present invention, a stopper locks an electric connection, at which a terminal and a coil are electrically connected with each other. Thus, the stopper limits a bending amount of bending the electric connection toward a yoke. In this structure, the electric connection can be bent toward the yoke until the electric connection contacts the stopper. Thus, the position of the stopper limits the bending amount of the electric connection. Accordingly, adjustment of the bending amount of the electric connection is facilitated. As a result, bending work of the electric connection is facilitated.

The electric connection and the yoke are prevented from approaching each other too close. Therefore, an insulation failure between the terminal or the coil and the yoke can be inhibited.

### BRIEF DESCRIPTION OF THE DRAWINGS

Features and advantages of embodiments will be appreciated, as well as methods of operation and the function of the related parts, from a study of the following detailed description, the appended claims, and the drawings, all of which form a part of this application. In the drawings:

FIG. 1 is a sectional view showing a fuel injection valve according to a first example embodiment of the present invention;

FIG. 2A is a view showing an electromagnetic drive device excluding a resin housing according to the first example embodiment;

FIG. 2B is a view showing the electromagnetic drive device of FIG. 2A in the direction of the arrow mark IIB;

FIG. 3A is a perspective view showing a spool according to the first example embodiment;

FIG. 3B is a view showing the spool of FIG. 3A in the direction of the arrow mark IIIB;

FIG. 4A is a view showing the spool of FIG. 3B in the direction of the arrow mark IVA;

FIG. 4B is a view showing the spool of FIG. 4A in the direction of the arrow mark IVB;

FIG. 5A is an explanatory diagram showing a molding process of the resin housing according to the first example embodiment;

FIG. 5B is an explanatory diagram showing the molding process of the resin housing of FIG. 5A in the direction of the arrow mark VB;

FIG. 6A is a view showing an electromagnetic drive device excluding a resin housing according to a second example embodiment of the present invention;

FIG. 6B is an enlarged view showing a part of the electromagnetic drive device of FIG. 6A indicated by the area VIB;

FIG. 7A is a view showing the electromagnetic drive device of FIG. 6A in the direction of the arrow mark VIIA;

FIG. 7B is an enlarged view showing a part of the electromagnetic drive device of FIG. 7A indicated by the area VIIB;

FIG. 8A is a perspective view showing a spool according to the second example embodiment;

FIG. 8B is a view showing the spool of FIG. 8A in the direction of the arrow mark VIIIB;

FIG. 9A is a view showing the spool of FIG. 8B in the direction of the arrow mark IXA;

FIG. 9B is a view showing the spool of FIG. 9A in the direction of the arrow mark IXB; and

FIG. 10 is a view showing an electromagnetic drive device of a related art.

### DETAILED DESCRIPTION OF EXAMPLE EMBODIMENTS

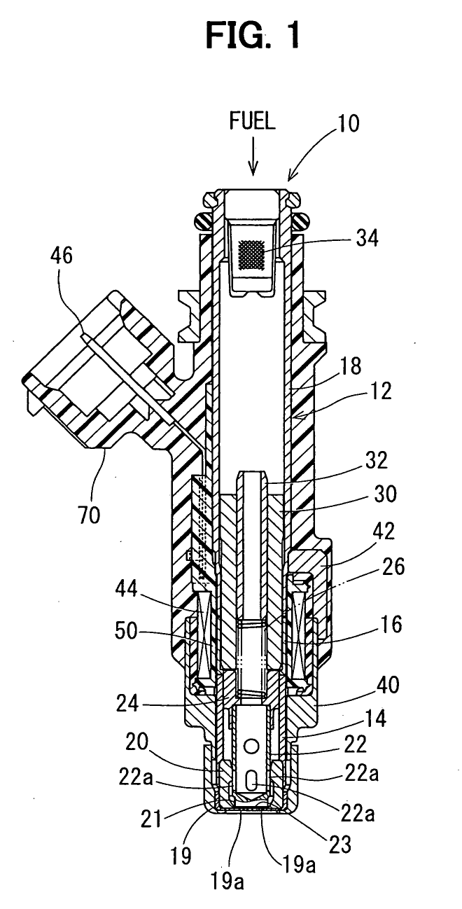

Referring to FIG. 1, a fuel injection valve using an electromagnetic drive device according to a first example embodiment of the present invention is illustrated. The fuel injection valve 10 is used in a gasoline engine. A cylindrical member 12 of the fuel injection valve 10 is made of a magnetic material and a non-magnetic material and is formed in a cylindrical shape. A fuel passage is formed radially inside the cylindrical member 12. The fuel passage of the cylindrical member 12 accommodates a valve body 20, a valve member 22, a movable core 24, a spring 26, a fixed core 30, an adjusting pipe 32 and a fuel filter 34. The fuel injection valve 10 further includes yokes 40, 42, a coil 44, terminals 46, a spool 50 and a resin housing 70. The yokes 40, 42, the coil 44, the terminals 46, the spool 50 and the resin housing 70 constitute an electromagnetic drive device of the fuel injection valve 10.

The cylindrical member 12 has a first magnetic member 14, a non-magnetic member 16 as a magnetic resistance member and a second magnetic member 18 in that order from a valve body 20 side (lower side in FIG. 1) and is formed as an integrated body. The cylindrical member 12 is located radially inside the coil 44 and covers outer peripheries of the movable core 24 and the fixed core 30. The first magnetic member 14 is bonded with the non-magnetic member 16 through a welding process. The non-magnetic member 16 is bonded with the second magnetic member 18 through a welding process. For example, laser welding process is performed as the welding process. The first and second magnetic members 14, 18 of the cylindrical member 12, the movable core 24, the fixed core 30 and the yokes 40, 42 form a magnetic circuit. The non-magnetic member 16 prevents a short circuit of a magnetic flux between the first and second magnetic members 14, 18. The fuel filter 34 is accommodated in a fuel inlet portion of the cylindrical member 12.

The valve body 20 is fixed to an inner periphery of a tip end of the first magnetic member 14 on an injection hole side through a welding process. The valve body 20 has a valve seat 21 on an inner peripheral wall thereof. The valve member 22 can be seated on the valve seat 21. A cup-shaped injection hole plate 19 is fixed to an outer peripheral wall of the valve body 20 through a welding process. The injection hole plate 19 has a thin plate portion. Multiple injection holes 19a are formed in a central portion of the thin plate portion of the injection hole plate 19.

The valve member 22 is a hollow cylinder having a bottom face. A contact portion 23 is provided on the bottom face of the valve member 22. The contact portion 23 can be seated on the valve seat 21 formed on the valve body 20. If the contact portion 23 is seated on the valve seat 21, the injection holes 19a are blocked and fuel injection is interrupted. Multiple fuel holes 22a are formed to penetrate through a side wall of the valve member 22 upstream of the contact portion 23. The fuel flowing into the valve member 22 passes through the fuel holes 22a from an inside to an outside, and then, flows toward a valve portion provided by the contact portion 23 and the valve seat 21.

The movable core 24 is fixed to the valve member 22 through a welding process and the like on a side opposite from the valve body 20 with respect to the valve member 22. The spring 26 as a biasing member biases the movable core 24 and the valve member 22 in a direction for seating the valve member 22 on the valve seat 21.

The fixed core 30 is formed in a cylindrical shape and is accommodated in the cylindrical member 12. The fixed core 30 is located on a side opposite from the valve body 20 with respect to the movable core 24 so that the fixed core 30 faces the movable core 24.

The adjusting pipe 32 is press-fit into the fixed core 30 to lock an end of the spring 26. The biasing force of the spring 26 is adjusted by adjusting a press-fitting amount of the adjusting pipe 32.

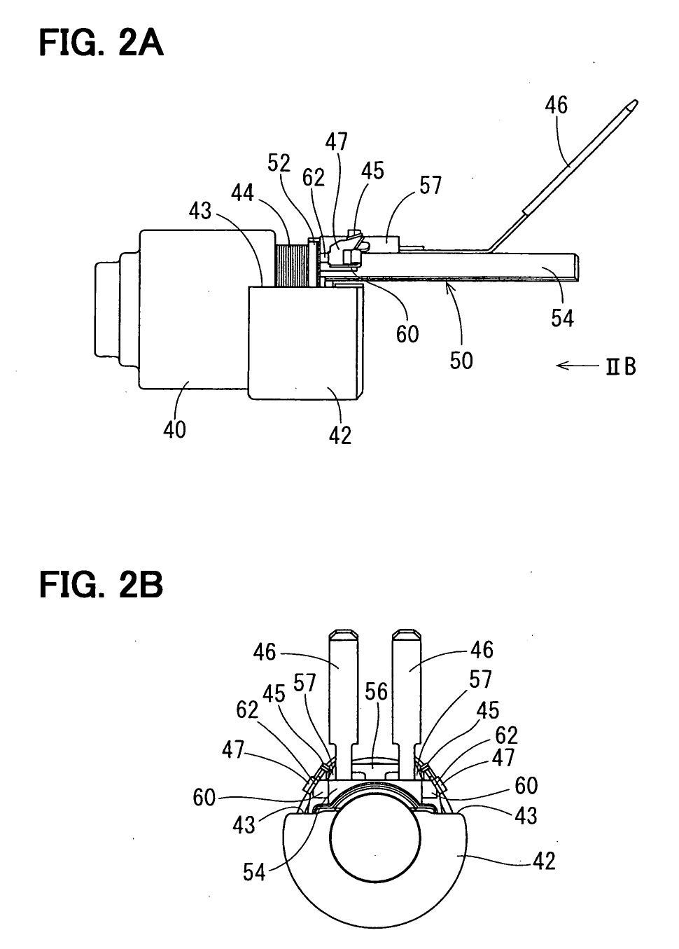

The yokes 40, 42 are magnetically connected with each other and cover an outer periphery of the coil 44. The yoke 40 is formed in a cylindrical shape and is magnetically connected with the first magnetic member 14. The yoke 42 is magnetically connected with the second magnetic member 18. As shown in FIGS. 2A and 2B, a part of a circumference of the yoke 42 is cut to avoid contact with a connection between the terminals 46 and the coil 44. That is, the yoke 42 has an opening in a part of the circumference thereof.

The spool 50, around which the coil 44 is wound, is fit around an outer periphery of the cylindrical member 12. The resin housing 70 covers outer peripheries of the cylindrical member 12 and the coil 44. The terminals 46 are electrically connected with the coil 44 to supply drive current to the coil 44.

The fuel flowing into the fuel injection valve 10 through an upper portion of the cylindrical member 12 flows through a fuel passage inside the fixed core 30, a fuel passage inside the movable core 24, a fuel passage inside the valve member 22, the fuel holes 22a , and an opening that is formed between the contact portion 23 and the valve seat 21 when the contact portion 23 separates from the valve seat 21 and is injected through the injection holes 19a.

In the fuel injection valve 10, if the energization of the coil 44 is stopped, the valve member 22 moves downward in FIG. 1, or moves in a valve-closing direction, because of the biasing force of the spring 26. Accordingly, the contact portion 23 of the valve member 22 is seated on the valve seat 21 and the injection holes 19aare blocked. Thus, the fuel injection is interrupted.

If the coil 44 is energized, a magnetic flux flows through a magnetic circuit formed by the fixed core 30, the movable core 24, the first magnetic member 14, the yokes 40, 42 and the second magnetic member 18. Thus, a magnetic attraction force is generated between the fixed core 30 and the movable core 24. Accordingly, the movable core 24 and the valve member 22 move toward the fixed core 30 against the biasing force of the spring 26. As a result, the contact portion 23 separates from the valve seat 21. Thus, the fuel is injected through the injection holes 19a.

Next, an electromagnetic drive device used in the fuel injection valve 10 will be explained.

The electromagnetic drive device excluding the resin housing 70 is shown in FIGS. 2A and 2B. The yoke 42 has an opening in a part of the circumference thereof as explained above. Ends 45 of the coil 44 are electrically connected with ends 47 of the terminals 46 between circumferential ends 43 of the yoke 42 defining the opening.

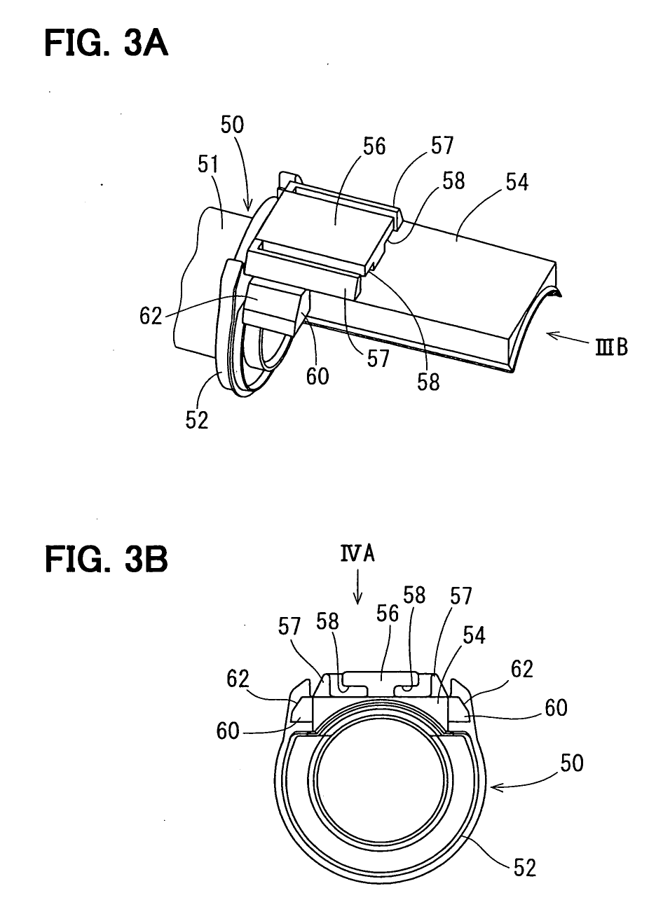

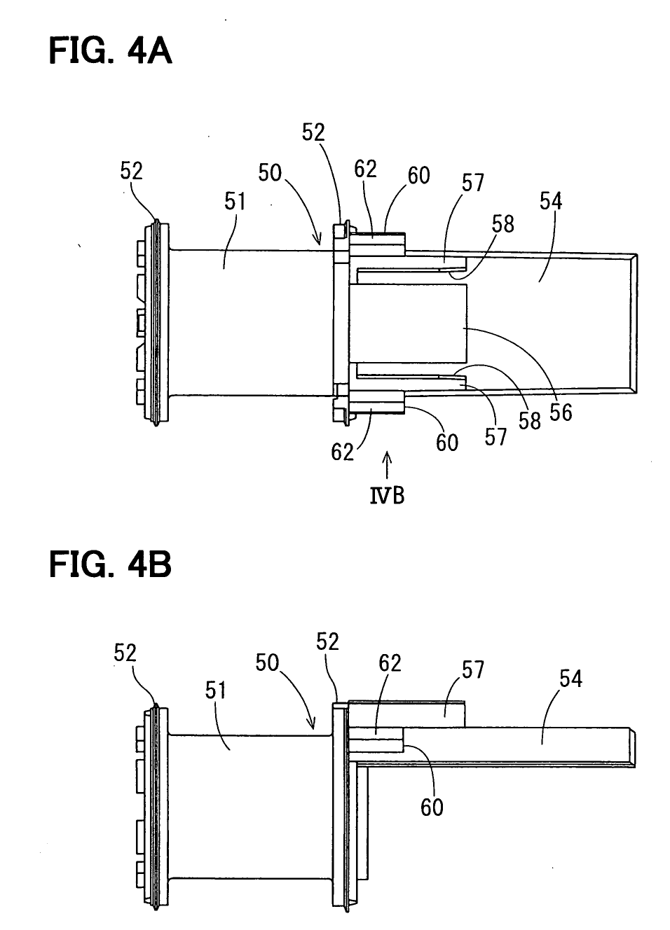

The spool 50 is shown in FIGS. 3A to 4B. The spool 50 is made of an insulating resin material. The spool 50 has a winding portion 51, flange portions 52, a guiding portion 54, fitting portions 56, 57 and protrusions 60. The winding portion 51 is formed in a cylindrical shape. The coil 44 is wound around the winding portion 51. The flange portions 52 are formed on both axial ends of the winding portion 51. Each flange portion 52 is formed in an annular shape having a larger diameter than the winding portion 51. The flange portions 52 prevent collapse of the winding of the coil 44.

A section of the guiding portion 54 is formed in the shape of an arc. The guiding portion 54 extends in an axial direction and guides the terminals 46. The fitting portions 56, 57 are formed on the guiding portion 54 near the winding portion 51. The fitting portion 56 is located at the center of the guiding portion 54 with respect to the circumferential direction. The fitting portions 57 are formed on both sides of the fitting portion 56 with respect to the circumferential direction. The guiding portion 54, the fitting portion 56 and the two fitting portions 57 provide two fitting concave portions 58. The two terminals 46 are fit to the fitting concave portions 58 respectively and are positioned. Each fitting concave portion 58 is narrow at an outside with respect to the radial direction. Accordingly, the terminals 46 are prevented from falling off radially outward in a state in which the terminals 46 are fit to the fitting concave portions 58.

The protrusions 60 are formed as stoppers on both side faces of the guiding portion 54 with respect to the circumferential direction near the winding portion 51. Tapered faces 62 are formed on respective side faces of the protrusions 60. The tapered faces 62 are inclined toward the yoke 42. Each end 47 of the terminal 46 electrically connected with the corresponding end 45 of the coil 44 is bent toward the yoke 42 with the end 45. Thus, the end 47 contacts the tapered face 62 of the protrusion 60. The end 45 of the coil 44 and the end 47 of the terminal 46 constitute an electric connection. When the end 47 of the terminal 46 is bent toward the yoke 42, the end 47 is bent until the end 47 contacts the tapered face 62.

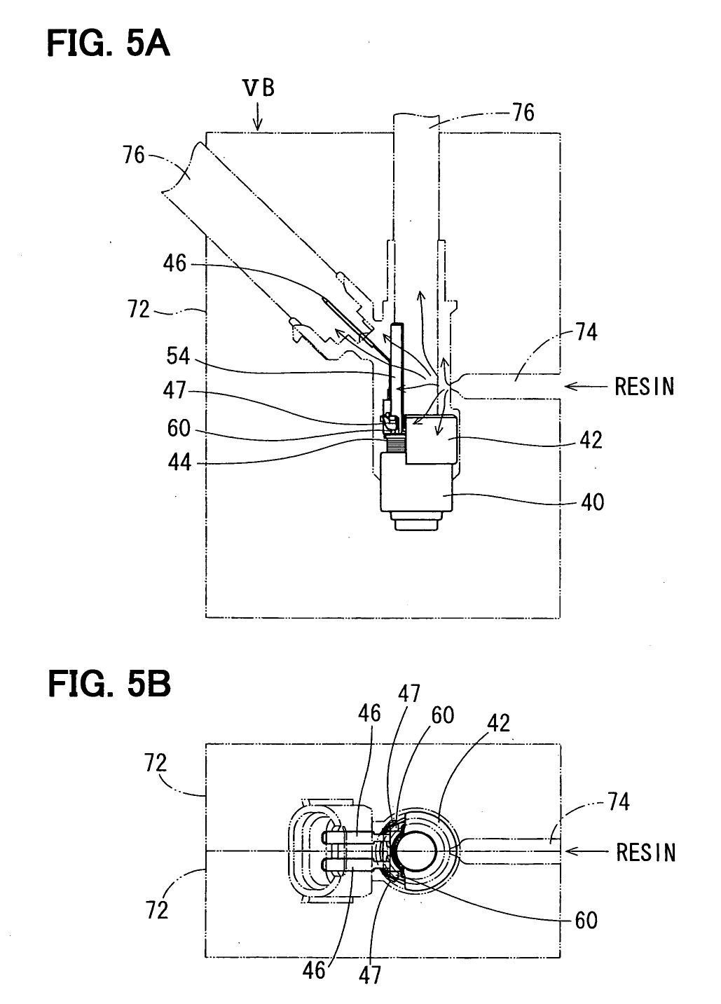

The ends 47 of the terminals 46 are bent toward the yoke 42, and the assembled coil 44, terminals 46 and spool 50 as shown in FIGS. 2A and 2B are set in a molding apparatus 72 as shown in FIGS. 5A and 5B. Then, a resin is injected through a gate 74 to form the resin housing 70. Slides 76 used in the molding process of the resin housing 70 are positioned in two directions of an axial direction of the spool 50 and a direction of the terminals 46 as shown in FIG. 5A. Therefore, the gate 74 for injecting the resin is positioned on an opposite side as the terminals 46 with respect to the guiding portion 54 of the spool 50, or on a side (yoke 42 side) toward which the ends 47 of the terminals 46 are bent. Accordingly, the resin injected from the gate 74 flows toward the ends 47 of the terminals 46 from the side opposite from the ends 47 with respect to the protrusions 60. The protrusions 60 are located on a yoke 42 side (gate 74 side) toward which the ends 47 are bent. Therefore, the flow of the resin injected from the gate 74 is blocked by the protrusions 60 and takes a detour. Thus, the injected resin does not generate a flow that pushes the ends 47 toward original positions opposite to the bending direction. Thus, the ends 47 of the terminals 46 are prevented from being pushed toward the surface of the resin housing 70.

The end 47 of each terminal 46 contacts the tapered face 62 in a wide area. Accordingly, a clearance between the end 47 and the tapered face 62 is narrow. As a result, it is difficult for the resin to flow into the clearance between the end 47 of the terminal 46 and the tapered face 62. Accordingly, the end 47 of the terminal 46 is prevented from being pushed toward the surface side of the resin housing 70. Thus, the ends 47 of the terminals 46 are prevented from being returned in a direction opposite to the bending direction. As a result, tension applied to the coil 44 connected with the ends 47 can be suppressed. The electric connection does not strike against the tapered face 62 in a narrow area when the electric connection is bent toward the yoke 42. Accordingly, the electric connection is prevented from being applied with a large local force. As a result, deformation of the electric connection can be prevented when the tapered face 62 locks the electric connection.

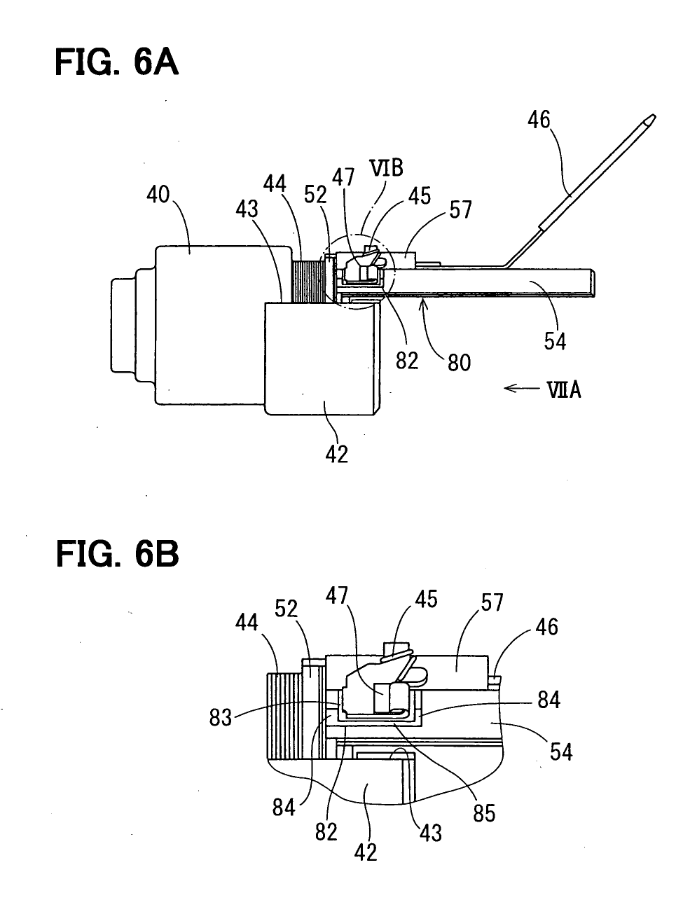

Next, an electromagnetic drive device according to a second example embodiment of the present invention will be explained with reference to FIGS. 6A to 9B.

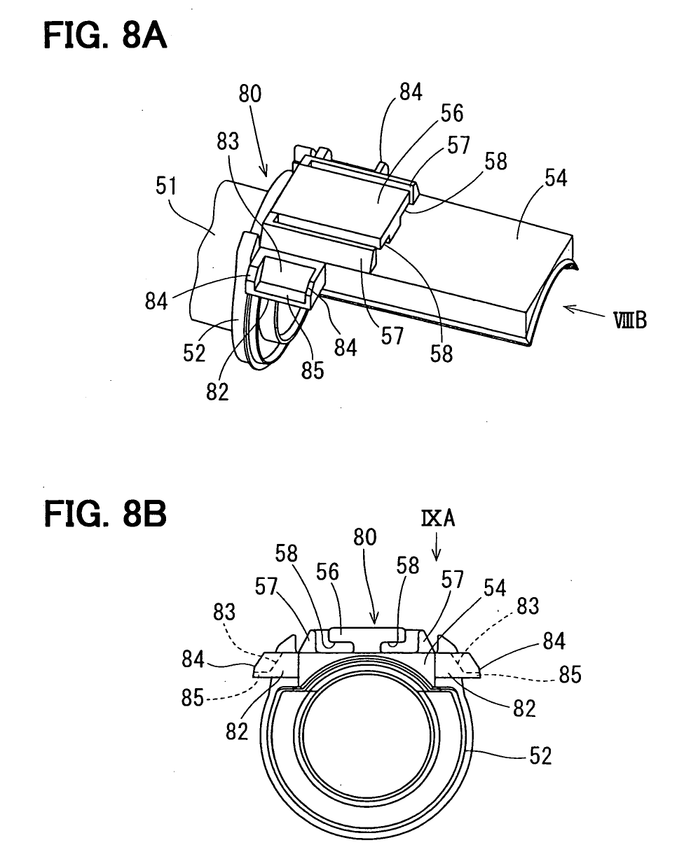

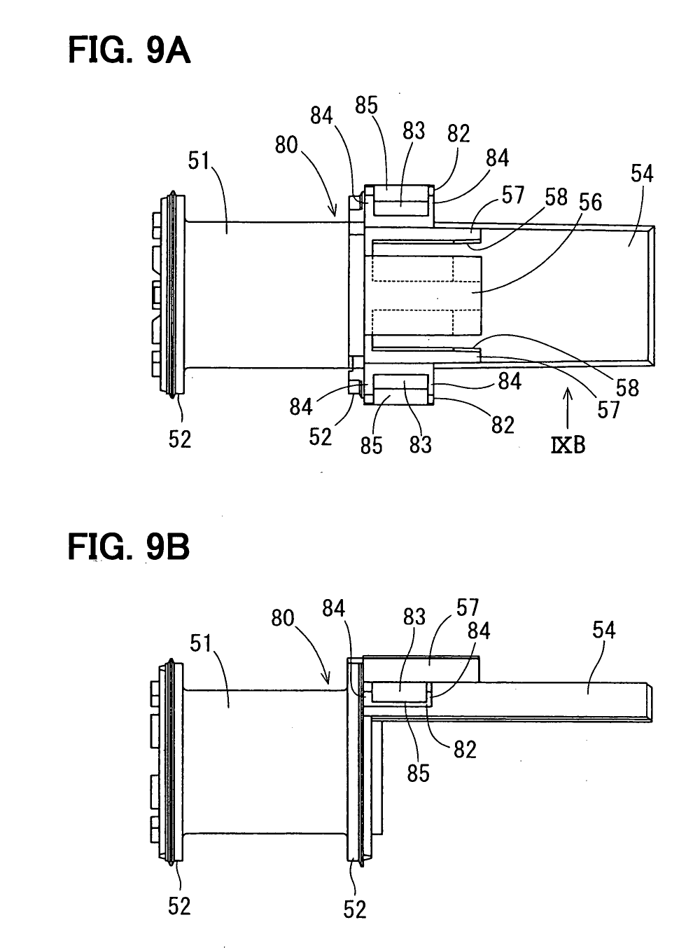

As shown in FIGS. 8A to 9B, protrusions 82 as stoppers are formed on a spool 80 and are respectively formed with tapered faces 83 inclined toward the yoke 42 like the first example embodiment. Shielding portions 84 are formed on both axial sides of each tapered face 83, and a shielding portion 85 is formed on a yoke 42 side of the tapered face 83. Thus, the shielding portions 84, 85 surround the tapered face 83.

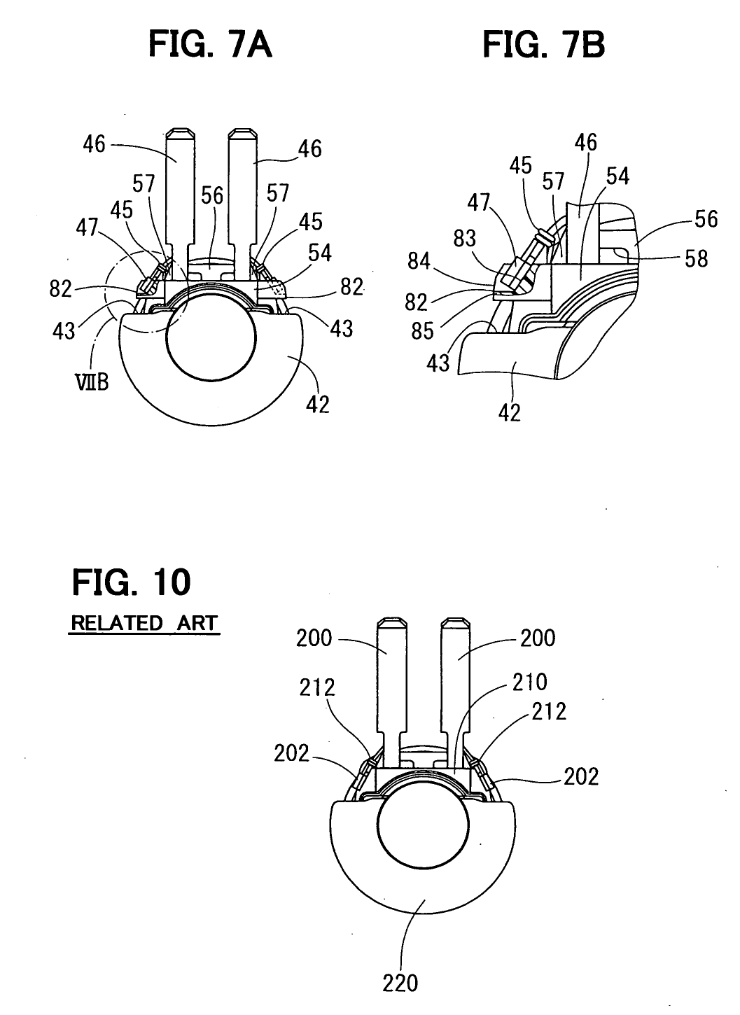

As shown in FIGS. 6A to 7B, the ends 47 of the terminals 46 electrically connected with the ends 45 of the coil 44 are bent toward the yoke 42 so that the ends 47 respectively contact the tapered faces 83 surrounded by the shielding portions 84, 85. The shielding portions 84, 85 surround the peripheries of the ends 47 in a state in which the ends 47 contact the tapered faces 83.

Thus, a flow of the resin that is generated during the molding process of the resin housing 70 and is directed toward the ends 47 is blocked by the shielding portions 84, 85 and takes a detour. Each end 47 of the terminal 46 contacts the tapered face 83 in a wide area. Accordingly, a clearance between the end 47 and the tapered face 83 is narrow. As a result, it is difficult for the resin to flow into the clearance between the end 47 of the terminal 46 and the tapered face 83. Thus, the end 47 of the terminal 46 is prevented from being pushed toward the surface of the resin housing 70. Since the shielding portions 84 cover the both axial sides of each end 47, axial movement of the end 47 due to the flow of the resin can be prevented.

In the above embodiments, the ends 47 of the terminals 46, which are electrically connected with the coil 44, are bent toward the yoke 42 until the ends 47 are stopped by the protrusions provided as the stoppers. Thus, the stoppers can limit the bending amounts of the ends 47. Accordingly, bending work of the ends 47 as the electric connections between the coil 44 and the terminals 46 is facilitated.

Since the stoppers stop the ends 47 of the terminal 46, the ends 47 do not approach the yoke 42 further than the stoppers. Thus, an insulation failure, which can be caused when the ends 47 of the terminals 46 approach the yoke 42 too close, can be prevented. Thus, the fuel injection valve using the electromagnetic drive device of each one of the above example embodiments as a drive portion can prevent an insulation failure between the coil 44 or the terminals 46 and the yoke 42. As a result, an energization control failure of the coil 44 can be prevented. Accordingly, continuous fuel injection due to an insulation failure or an injection quantity control failure due to a deviation of opening-closing timing of the valve member 22 can be prevented. Thus, the fuel injection quantity can be controlled highly accurately.

When the resin housing 70 is formed through the resin molding process, the stoppers block the flow of the resin in a direction opposite to the bending direction of the ends 47 of the terminals 46. Accordingly displacement of the ends 47 in the direction opposite to the bending direction can be prevented. Thus, exposure of the ends 47 to the surface of the resin housing 70 can be prevented. In addition, in the second example embodiment, the stoppers block the flow of the resin in the axial direction and prevent the displacement of the ends 47. Therefore, a tension applied to the coil 44 because of the displacement of the ends 45 of the coil 44 with the ends 47 of the terminals 46 can be prevented.

In the above example embodiments, the tapered faces are formed on the protrusions, which are provided as the stoppers formed on the spool, so that the tapered faces are inclined toward the yoke 42. Alternatively, the tapered faces may not be formed on the stoppers just for limiting the bending amounts of the ends 47 of the terminals 46, which are electrically connected with the coil 44, toward the yoke 42. Instead of the spool itself, stopper members located on the spool may provide the stoppers that limit the bending amounts of the ends 47 of the terminals 46.

In the above example embodiments, the electromagnetic drive device of the present invention is applied as the electromagnetic drive device of the fuel injection valve. The electromagnetic drive device of the present invention may be applied to any usage in addition to the fuel injection valve.

The present invention should not be limited to the disclosed embodiments, but may be implemented in many other ways without departing from the spirit of the invention.

What is claimed is:

1. An electromagnetic drive device including a coil, a terminal electrically connected with the coil, and a yoke covering at least a part of an outer periphery of the coil, wherein an electric connection between the coil and the terminal is bent toward the yoke, the electromagnetic drive device comprising:
a stopper for locking the electric connection to limit a bending amount of the electric connection toward the yoke.

2. The electromagnetic drive device as in claim 1, wherein the yoke is formed with an opening in a part of a circumference thereof, and
the electric connection is bent toward a circumferential end of the opening.

3. The electromagnetic drive device as in claim 1, further comprising:
a resin housing provided by a resin molding that covers the coil, the terminal and the yoke.

4. The electromagnetic drive device as in claim 1, further comprising:
a spool, around which the coil is wound, wherein the stopper is a protrusion formed on a side face of the spool.

5. The electromagnetic drive device as in claim 1, wherein the stopper is formed with a tapered face, which the electric connection contacts when the electric connection is bent toward the yoke.

6. The electromagnetic drive device as in claim 1, wherein the stopper covers a periphery of the electric connection.

7. The electromagnetic drive device as in claim 3, wherein the resin housing is formed through a resin molding process, in which a resin is injected from a gate of a molding apparatus, and
the stopper is located between the gate and the electric connection during the molding process.

8. A fuel injection valve, comprising:
the electromagnetic drive device as in claim 1;
a fixed core;
a movable core that is attracted toward the fixed core by an electromagnetic attraction force generated by the electromagnetic drive device; and
a valve member that reciprocates with the movable core to inject fuel intermittently.
